(19) United States
(12) Patent Application Publication
(10) Pub. No.: US 2023/0227653 A1
(43) Pub. Date: Jul. 20, 2023

(54) Flame Retardant Bio-based Thermal Interface Material

(71) Applicants: Kurtis Zhang, York, PA (US); Lida Lu, Rockville, MD (US); Arthur Yang, Bethesda, MD (US)

(72) Inventors: Kurtis Zhang, York, PA (US); Lida Lu, Rockville, MD (US); Arthur Yang, Bethesda, MD (US)

(21) Appl. No.: 18/097,322

(22) Filed: Jan. 16, 2023

Related U.S. Application Data
(60) Provisional application No. 63/300,148, filed on Jan. 17, 2022.

(51) Int. Cl. C08L 89/06; C08K 3/016; H01M 10/653; H01M 10/658; C08K 7/00; C08K 3/04; C08K 3/30; C08K 3/34

(52) U.S. Cl. CPC C08L 89/06; C08K 3/016; H01M 10/653; H01M 10/658; C08K 7/00; C08K 3/042; C08K 3/30; C08K 3/346; C08L 2201/02; H01M 10/0525

(57) ABSTRACT

The present invention is directed to a flame retardant thermal interface material. The material contains a bio-based material and associated functional additives, wherein the bio-based material includes a protein and the functional additives include at least one of a char forming promotor, a char reinforce agent, a foaming agent, a thermal conductive agent, a flame suppression agent and other additives. The char forming promotor, the char reinforce agent and the flame suppression agent are used to adjust the combustion behavior of the material to render the material having desired flame retardation performance. The foaming agent and thermal conductive agent are used to adjust thermal conductivity of the material. The present invention is also directed to a process method of making a flame retardation thermal interface material.

### RELATED APPLICATIONS

This application claims the benefit of provisional patent application No. 63/300,148, filed on Jan. 17, 2022. The entire contents of the priority application is incorporated herein by reference.

### FIELD OF INVENTION

The present invention is directed to a flame retardation thermal interface material for lithium battery packing. The material contains a bio-based material and associated additives, wherein the bio-based material includes one of bio-available materials based on inexpensive and abundant proteins. The present invention is also directed to a process of making flame retardation thermal interface materials including a microwave foaming step.

### BACKGROUND OF THE INVENTION

Lithium-ion batteries are the most used rechargeable batteries in the world for their high energy density. The lithium batteries are used in almost all consumer electronics, power tools, power storage for solar energy, and new generation electric vehicles. However, there are two big issues associated with these applications which are thermal management and fire risk of lithium battery packs.

Heat management is an important operating factor for a lithium battery in terms of its performance and lifetime. The lithium battery generally provides the highest capacity in an operation temperature range of 10° C. to 40° C., which is known in the art. It has been reported (by CED Greentech) that higher operation temperature may significantly decrease the life cycle of a Lithium-ion battery over time. For the first 200 cycles the battery performance only degraded 3.3% at 25° C., at 45° C. the performance decreased by 6.7%; that is more than double the amount of degradation. The greater degradation of the battery cell at higher temperatures can severely reduce the battery life cycle due to consistent heat from the operation of these battery cells. In the normal working condition, the discharge-recharge of the battery produces heat due to internal resistance of the battery; therefore, in order to keep the battery pack at a relatively lower working temperature and storage temperature, good thermal conductivity at normal operation condition of the lithium batteries is vital for a battery pack.

The fire and explosion are big risks associated with the application of Lithium-ion batteries. The U.S. Department of Transportation's (DOT's) Hazardous Materials Regulations (HMR; 49 C.F.R., Parts 171-180) classifies lithium ion batteries as hazardous materials. Therefore, packing, storing and shipping lithium batteries to reduce the hazardous fire incidents are essential practices and the related materials play an important role in this field.

Thermal runaway is the most common cause for the fire incidents of the Lithium-ion batteries. The thermal runaway is the term that has been used to describe a cell that it self-heats faster than it cools until it reaches a failure temperature. The thermal runaway of a typical cell is a series of chemical reactions and mechanical events which leads the temperatures to go out of control and reach a certain range that the exothermic reaction inside the batteries start to rapidly accelerate and further heats up the battery cell. The positive heat feedback cycle may result in fire and explosion.

Thermal runaway starts from the overheating of the battery system. The initial overheating can occur as a result of the battery being overcharged, exposure to excessive external heating source, external short circuit due to faulty wiring, or internal short circuits due to cell defects or cell damage in many circumstances such as external metal debris penetration; vehicle collision and lithium dendrite formation. Accidents associated with thermal runaway have been reported on many occasions, for example, a UPS flight departed from Dubai and, shortly crashed after takeoff, the likely cause was thermal runaway of lithium batteries; a Tesla car hit metal debris that pierced the shield and the battery pack. The debris penetrated the polymer separators and connected the cathode and anode, causing the battery to short circuit and to catch fire; and the Samsung Note 7 battery fires due to damage of the ultrathin separator that causes the battery to short-circuit.

In some occasions, when battery voltage decreases near the end of its capacity, the current must increase to maintain constant power; this increases internal resistance of the battery cell to produce more heat and can result in a large temperature increase and reach the thermal runaway point of a lithium battery cell. Overcharge may also result in overheating of a battery cell to reach thermal runaway temperature. Under a normal working condition of a Lithium-ion battery, good thermal conductivity of the packing material may allow the heat being quickly dissipated to decrease the chance of the temperature reaching thermal runaway point thus reducing the risk of hazardous fire of the battery.

In most cases, the thermal runaway may only occur in a single battery cell, thus it is vital that the damaged or burnt battery cell is isolated to stop or reduce the heat or fire being spread quickly to the next cell to alleviate further fire risk. In the present practice, the lithium battery is generally packed individually in its application setup, storage or on transportation, wherein a separator made from metal, or organic materials such as plastic and fiberboard may be used to fix each individual battery cell in its position to prevent its movement and provide sufficient impact resistance. The separator is also expected to prevent runaway heat from one cell transferring to the next cell. In the lithium battery application packs, a thermal interface material is generally disposed between individual battery cells to function as the separator. The thermal interface material also couples the lithium-ion batteries to a heat sink to transfer and dissipate heat from batteries during their charging-discharging cycle. The thermal interface material can further be incorporated into other areas to ensure good thermal contact between the battery pack and housing or frame structure of the battery pack.

As discussed above, as an ideal lithium battery thermal interface material for battery packing, it should provide good thermal conductivity at normal operating temperature and storage temperature to render better operating performance and prevent lithium batteries from increasing temperature to cause thermal runaway; and good thermal insulation when the temperature of the battery cell reaches dangerous high level, specifically when the battery cell is on fire or thermal runaway of the battery occurs. The good thermal conductivity may keep each individual battery cell at an optimized operation temperature and reduce the chance of a single battery reaching its onset temperature of thermal runaway. However, when a thermal runaway or a fire occurs, the thermal insulation comes into effect to prevent the adjacent battery cells from reaching the thermal runaway onset temperature or burning temperature.

As a thermal interface material for lithium battery packing, to minimize fire risk and meet fire safety requirements is critical. Flame retardation treatments by interfering combustion of an organic material such as polymer resin based material of plastic, coating and adhesive with various physical or chemical strategies to prevent the ignition of the materials, to decease flame active species concentration from degradation of the material, or/and to lower the heat released during their combustion, have been developed. The most common practice is to incorporate one or more flame retardation additives (flame retardants) into organic materials to obtain desired flame retardation requirements. The main categories of flame retardant include inorganic compounds, halogenated compounds, or phosphorus-containing compounds. Halogenated compounds, acting in the vapor phase by scavenging flame active species free radicals by releasing halogen radicals that inhibit combustion, are highly efficient fire retardants. However, due to environmental and health concerns, the use of halogenated flame retardants has been restricted or forbidden. These flame retardants generate large amounts of smoke and corrosive gasses during combustion, and they are persistent environment pollutants after migrating out of the polymer matrix. To address these problems, considerable attention has been devoted to the development of halogen-free flame retardant additives. Inorganic flame retardants, such as aluminum trihydroxide and magnesium hydroxide, can be effective in diluting flame active species by releasing water molecules and block heat cycle by forming an inorganic barrier layer. The phosphorus-containing flame retardant is another efficient flame retardant which promotes insulating char layer formation to block heat cycle and reduces generation of flame active species. The formation of this char results from the oxidation of the phosphorus compounds and their interaction with the polymer matrix during combustion. An intumescent fire retardation system containing char forming agent, foaming agent and char forming catalyst and acting as a thermal insulation barrier that protects the underlying material against rapid increases in temperature to the ignition point, which is one of the most promising environmentally friendly strategies for replacing halogenated compounds.

Petroleum-based synthetic plastic pollution is a major global problem today. The synthetic plastics take a long period of time to decompose, and some of them never completely break down, which means that billions of tons of plastic dumped on the earth might get broken down into microscopically small pieces. These tiny plastic particles are harmful to the environment especially to the fresh water sources and freshwater ecosystem. To address this big problem on our planet, considerable efforts have been made to develop biobased materials, especially from renewable resources such as agricultural byproducts and other biomass. The biobased materials generally degrade in a relatively short period of time in the normal environment by action of microorganisms.

There are many advantages of bio-based materials such as renewable, sustainable, fossil resources saving and environmental impact reduction. The growth of more effective biorefinery processes, enabling the extraction of a large range of bio-based materials, offers great opportunities to support bio-based material production and to urge on the development of new high value applications for some bio-based materials. Newly developed biosynthesis technology potentially provides a promising way to design and make new generations of bio-based material with desired properties to meet a variety of applications. Various bio-based compounds, especially protein, has potential to be used as intumescent flame retardant material owing to their chemical structure including nitrogen and other elements with char-forming ability. The production at material's surface of thermally stable charred structures change its fire behavior by reducing the diffusion of oxygen and heat, and inhibiting further volatilization of combustible products.

The objective of the present invention is to provide a bio-based flame retardant thermal interface material which has good thermal conductivity at normal operating temperature of a lithium-ion battery. The material also possesses excellent flame retardation performance and provides an insulating barrier protecting the underlying battery cells at elevated temperatures, especially when the temperature reaches onset temperature of thermal runaway of a Lithium-ion battery or a battery pack is on fire. Another objective of the present invention is to provide a method of making the bio-based flame retardation material.

### SUMMARY OF THE INVENTION

The present invention is directed to a flame retardation thermal interface material for lithium battery pack and other electronic devices. Specifically, this invention provides a new thermal interface material with excellent flame retardation performance. The material provides good thermal conductivity at normal operating and storage conditions of a lithium battery to provide optimized operating temperature and to prevent lithium batteries from increasing temperature to cause thermal runaway; and forms an thermal insulating barrier when the temperature of the battery cell reaches dangerous high level, specifically the cell is on fire or thermal runaway of the battery occurs. The material comprises a bio-based material and functional additives. The bio-based material is an inexpensive and abundant protein including at least one of wheat gluten, casein, collagen, gelatin and soy-protein; and the functional additives includes at least one of a char forming promotor, a char reinforce agent, a foam forming agent, a flame suppression agent, a thermal conductive agent, a crosslinking agent, and/or a plasticizer. The char forming promotor, the char reinforce agent and flame suppression agent are used to adjust the combustion behavior of the material to render the material having desired flame retardation performance. The foaming agent is used to expand the material to provide desired thermal insulation to reduce heat transfer at elevated temperature or during combustion of the material. The thermal conductive agent is used to adjust thermal conductivity of the material at normal operating temperature, and crosslinking agent and the plasticizer is used to adjust mechanical properties of the material. The present invention is also directed to a process method of making a flame retardation thermal interface material including one of a melt extrusion process, water casting process and a water induced flocculation process, wherein a microwave foaming step is included to make the materials having desired porous structures.

### DETAILED DESCRIPTION OF THE PREFERRED EMBODIMENTS

In the present invention, a flame retardation thermal interface material composition and a method of making the same is presented. The composition comprises a bio-based material and functional additives, wherein the bio-based material is an inexpensive and abundant protein including at least one of wheat gluten, casein, collagen, gelatin and soy-protein; and the functional additives including at least one of a char forming promotor, a char reinforce agent, a foaming agent, a flame suppression agent, a thermal conductive agent, a crosslinking agent and a plasticizer. The char forming promotor, the char reinforce agent and the flame suppression agent are used to adjust the combustion behavior of the material to render the material having robust intumescent char layer and desired flame retardation performance. The foaming agent is used to adjust density of the material and/or further expand the material to provide thermal insulation to reduce heat transfer at elevated temperature or during combustion of the material. The thermal conductive agent is used to adjust thermal conductivity of the material at normal operating temperature, and the crosslinking agent and plasticizer are used to adjust mechanical properties of the material to fit its applications.

The protein can be any bioavailable protein, preferably a protein including wheat gluten, casein, collagen, gelatin and soy-protein; most preferably a wheat gluten (WG). The protein contains a large amount of hydroxyl group and carbonyl groups which can be dehydrated at elevated temperature to form a char. The protein also includes nitrogen-containing groups which generate non-combustible gasses such as NH₃, NO₂, CO₂ and H₂O. The non-combustible gasses make it possible for the char layer forming into an expanded char layer to provide good thermal insulation and protection for the underlying materials. The non-combustible gasses also dilute combustible gasses in the combustion zone.

Wheat gluten is a plant protein from wheat, which is an inexpensive and abundant raw material derived from renewable resources and is biodegradable. This protein is a co-product from gluten-starch separation or bioethanol product, and about 100 million pounds of wheat gluten are produced in the USA every year with a selling price lower than those of common synthetic thermoplastic materials such as polyethylene and polystyrene. It has been reported that the wheat gluten is stable under relatively dry conditions but can fully biodegrade in farmland soil without releasing toxic products, which makes it an ideal candidate for development of biodegradable materials.

The wheat gluten (WG) used for the present invention is in any form of wheat gluten, preferably a commercially available WG powder. Preferably, the WG powder comprises at least 60% by weight of gluten protein, more preferably, the WG powder comprises at least 70% by weight of gluten protein, and the most preferably the WG powder comprises at least 80% by weight of gluten protein. Typically, the WG powder comprises about 75% by weight of gluten protein, about 10% by weight starch, about 10% by weight moisture, about 5% by weight lipids, and about less than 1% by weight minerals. Alternatively, commercial WG powder purified by protein fractionation or extraction can also be used.

The char forming promotor is an inorganic particle including following metal oxide and mineral particles. The metal oxide particle includes but not limiting to silicon oxide, titanium oxide and the like; and the mineral particle includes calcium carbonate, calcium phosphate, dicalcium phosphate, kaolin clay, vermiculite clay, gypsum, wollastonite and the like. The preferred inorganic particles are silicon oxide, titanium oxide, calcium phosphate, dicalcium phosphate, gypsum and clays. The most preferred particles are gypsum and clays. The inorganic particle should be sufficiently small to be evenly dispersed in the protein-based matrix. The particle size of the inorganic particles can be in a range of 0.1 to 500 microns, preferably 0.5 to 350 microns, more preferably 1 to 250 microns. The content of the char forming promotor is in a range of 5 to 80%, preferably 10 to 70%, more preferably 20 to 60%, furthermore preferably 30 to 50%, by weight with respect to the total composition. The char forming promoter promotes dehydration of the protein and significantly increases char forming on the material surface during combustion of the material, and forms a stable char layer having small bubble size, reduces eruption of char surface by large bubble, and increases protective efficiency of the char layer. The inorganic particle generally has higher thermal conductivity than organic material, which increases thermal conductivity of the material. The incorporation of inorganic particles can also increase melt viscosity of the material to significantly reduce dripping of the material during combustion to stop fire spread. The incorporation of inorganic particles further reduces the content of the combustible organic matrix to suppress the flammability of the material.

The intumescent char layer having close cell structure generally provides better thermal protection to the inner layer of the material. However, during char forming period in the combustion of the material, a large amount of gaseous species generated from decomposition of the organic material can easily disrupt the char layer formed in the fire front of the material. In order to reduce this disruption and to form a stable char layer having foam of close cells, a char reinforce agent is added in the composition of the present invention in order to strengthen the char layer. The char reinforce agent can be a fibrous mineral particle, a plate-like mineral particle or a carbon-based particle. The fibrous mineral particles may include tremolite, chrysotile, riebeckite or the like. The plate-like particle may include talc, mica, expandable kaolin clay, expendable vermiculite, expandable perlite or the like. The carbon-based particle may include graphite, expandable graphite, carbon nanotube, carbon nanofiber, graphene, or graphene oxide. The carbon-based material also functions as a thermal conductive agent. The reinforce agent is fused with char formed from combustion to give the char having good cohesion. The preferred char reinforce agent is carbon-based material, and the most preferred char reinforce agent is graphite and expandable graphite. The char reinforce agent can also improve mechanical properties of the thermal interface material. The content of the char reinforce agent is in a range of 1 to 30%, preferably 2 to 25%, more preferably 5 to 20%, most preferably 5 to 10% by weight with respect to total composition.

The foaming agent includes a low temperature foaming agent and high temperature foaming agent. The low temperature foaming agent is used to expand the material to generate a foamed structure when the temperature reaches its decomposition temperature to provide thermal insulation effect. The low temperature foaming agent has a relatively lower decomposition temperature within a range of 125° C. to 400° C., preferably 150° C. to 350° C., more preferably 175° C. to 300° C. This foaming agent is generally an endothermic chemical foaming agent including ammonium carbonate, ammonium bicarbonate, potassium bicarbonate, sodium bicarbonate, calcium azide, azodicarbonamide, hydroazocarbonamide, ascorbic acid or citric acid. The content of the low temperature foaming agent is in a range of 1 to 30%, preferably 1 to 20%, more preferably 1 to 15%, most preferably 1 to 10% by weight with respect to total composition.

The high temperature foaming agent is used to adjust expansion of the char layer to render the char layer having good thermal insulation to reduce heat and mass transfer from combustion zone to the condensed phase of the material. The high temperature foaming agent has a relatively higher decomposition temperature within a range of 300° C. to 600° C., preferably 350° C. to 550° C., more preferably 400° C. to 500° C. The foaming agent is generally a nitrogen containing compound including urea, melamine, melamine phosphate, melamine polyphosphate, melamine, cyanyurtae, dicyandiamide, ammonium glyoxylate, ammonium phosphate, or ammonium polyphosphate, or polyethylenimine (PEI). Some foaming agents such as urea and PEI may also function as a plasticizer to adjust the flexibility of the material. Ammonium phosphate and ammonium polyphosphate also function as a char forming promotor. The content of the high temperature foaming agent is in a range of 1 to 40%, preferably 1 to 30%, more preferably 1 to 20%, most preferably 1 to 10% by weight with respect to total composition.

A flame suppression agent may also be added in the composition to further reduce the flammability of the material. The flame suppression agent include inorganic compounds such as alumina trihydrate (ATH) and magnesium hydroxide to provide vapor of H₂O to reduce the concentration of the combustible gasses in the combustion zone; or ferrous compound or cupric compound as a free radical scavenger. The ferrous compound can be ferrous gluconate, ferrous chloride, ferrous nitrate or ferrous sulfate. Cupric compounds can be copper oxide, cupric nitrate, cupric chloride or cupric sulfate. Smoke suppressant additives such as molybdenum trioxide, ammonium octamolybdate, iron oxide, or ferrocene may also be added to reduce smoke during burning of the material. The content of the flame or smoke suppression agent are in a range of 1 to 40%, preferably 2.5 to 30%, more preferably 5 to 20%, most preferably 5 to 10% by weight with respect to total composition.

The crosslinking agents include but are not limited to a low toxic difunctional aldehyde, glutaraldehyde, polythiols or a mixture thereof. The crosslinking agent is used to adjust mechanical properties of the material and also render the burning front of the material having sufficient melt strength to prevent dripping and promote char forming. The content of the flame or smoke suppression agent are in a range of 1 to 20%, preferably 1 to 10%, more preferably 1 to 5% by weight with respect to total composition.

The thermal conductive agents are not particularly limited, but preferably inorganic particles or carbon-based material having a thermal conductivity of 1 W/(mK) or more. The inorganic particle preferably at least one selected from the group consisting of a metal nitride, a metal carbide, and a metal oxide. Preferably, the metal nitride includes at least one of boron nitride, silicon nitride, aluminum nitride, silicon carbide; the metal oxide includes aluminum oxide, magnesium oxide, zinc oxide, and beryllium oxide. More preferably, the thermal conductive agent is an inorganic particle having high thermal conductivity, which includes boron nitride with thermal conductivity about 60 W/(mK), silicon nitride with thermal conductivity about 50 W/(mK), silicon carbide with heat conductivity about 270 W/(mK), aluminum oxide with heat conductivity about 30 W/(mK), magnesium oxide with heat conductivity about 40 W/(mK), and zinc oxide with heat conductivity about 25 W/(mK). The carbon-based particle may include graphite, expandable graphite, carbon nanotube, carbon nanofiber, graphene, or graphene oxide. The preferred carbon-based material is graphite and expandable graphite. A commercially available expandable graphite flake, GRAFGUARD, from GrafTech International, can be used. The particle size of the thermal conductive agen is in a range of 5 to 500 microns, preferably 20 to 350 microns, and more preferably 50 to 250 microns. The expansion onset temperature of the expandable graphite is in a range of 150 to 500° C., more preferably 200 to 300° C. The content of the thermal conductive agent is in a range of 1 to 50%, preferably 2.5 to 40%, more preferably 5 to 30%, most preferably 10 to 20% by weight with respect to total composition.

One or more other plastic, coating or adhesive additives are added in the composition. In particular, one or more common plastic additives include a plasticizer, an antimicrobial agent, a fungicide, an antioxidant, a pigment, a light fasting agent or a mixture thereof can be used to render the material have desired properties or functions with respect to their specific applications. A small amount of environmental benign hydrophilic polymer such as polyvinyl alcohol, polyacrylic acid, polyvinyl pyrrolidone and their copolymers can be used to adjust the processability and mechanical properties of the final products. A plasticizer is used to adjust stiffness and flexibility of the product, wherein the content of the plasticizer depends upon the flexibility as needed, which is generally in a range of 5 to 40% by weight. The contents of other additives are generally in a range of 0.1 to 10% by weight as commonly used in the art.

In this invention, a process method of making the flame retardant thermal interface material is also presented. The material can be made by one of the process methods as known in the art such as a conventional dry process, a wet process, and a new process method comprising a water induced flocculation step.

In the conventional dry process, the material is formed by melt mixing and then shaped into desired forms by one of the plastics thermal process methods including thermo-compression molding, injection molding, and extrusion. Proteins generally have relatively low decomposition temperature, thus at least one of plasticizers is generally added to the composition protein to increase chain mobility of the proteins, and makes the protein being processed in a limited operation window with low temperatures. For example, in order to make the thermal process possible, gluten materials are generally processed between 80 and 130° C. by adding plasticizers. The dry process generally includes powder mixing step, heating and melt mixing step, and molding step.

In the conventional wet process, the material is formed by solvent casting. The solvent used to prepare the protein solution or dispersion is generally a mixture of water and alcohol or occasionally acetone. Dispersing proteins in a solvent may also require adding disruptive agents such as mercapto-ethanol, urea, sodium sulfite, sodium dodecyl sulfate or dithiothreitol (DTT), to adjust pH or control ionic strength to make more protein subunits available to interact with solvent molecules or other protein molecules. Solvent removal increases protein concentration in the solvent medium, which leads to the protein chain interpenetration and three-dimensional network formation. The polarity of the solvent need to be adjusted to sufficiently dissolve and/or expand protein molecular chains (dissolve sub-unit of crosslinked protein) in order to form an interpenetrated three dimensional network, otherwise, instead of forming a continuous plastic article, a powdery or a fragile product is formed after solvent removal. In order to adjust flexibility of the plastic product, a polar plasticizing agent can be added to break extensive intermolecular forces generated by hydrogen bonds, which increases mobility of the molecular chain.

In the process method with water induced flocculation, the material is formed by following steps: (1) add a protein powder with or without water insoluble functional additives into a hydrophilic solvent preferably a water miscible solvent, or a mixture of water and a water miscible organic solvent having a concentration at least 80% by volume to form an even protein dispersion; (2) add water into the protein dispersion from previous step (1) to decease the organic solvent concentration to less than 75% by volume of the water/solvent mixture, stir the dispersion to allow the protein or protein/additives well dispersed and forms a viscous dispersion; (3) add more water to the dispersion from previous step (2) to decrease organic solvent concentration to less than 20% by volume of the water/solvent mixture, stir the dispersion until all protein or protein//additives precipitate out; (4) collect the flocculent (precipitates) by filtration to remove the supernatant and obtain a fully hydrated protein dough; (5) add water soluble additives by kneading the dough at room temperature until the additives being completely absorbed; (6) mold the dough into desired shape to form an article; (7) dry the hydrated article at a preset temperature for a preset period of time to fix the article into a rigid or flexible final product; (8) foam the dried article by microwave to obtain products having porous structures.

Organic solvent is a hydrophilic or water miscible solvent selected from low molecular weight alcohol or ketone such as methanol, ethanol, propanol, isopropanol, butanol, isobutanol, acetone, methyl ethyl ketone and the like. Preferably, environmental benign or VOC exempt solvent such as isopropanol and acetone are used in the preparation of WG dispersion. Water is a purified water in a preferred pH range of 5.0 to 9.0, more preferably pH of 6.0 to 8.0, and most preferably pH of 6.5 to 7.5. Water is added to adjust the polarity of the solvent/water mixture to enhance dissolution or expansion of proteins.

In the flocculation step (3), a large amount of water is added to adjust organic solvent concentration to 20% or lower by volume of the solvent/water mixture. In this step, low speed stirring is applied to the dispersion until all the dispersed particles precipitate or co-precipitate out. The flocculent (precipitate) is collected as a hydrated dough after removing supernatant, the hydrated dough has low viscoelasticity which is readily molded into a desired shape to form an article. The flocculent can also be collected by filtration or centrifugation, when precipitates do not form a cohesive dough, which can be further kneaded into a dough with or without adding plastic additives. In another embodiment, the step (3) may directly follow step (1) as described above instead of following step (2), to obtain a fully hydrated protein material from step (1).

The dough collected from previous steps is formed into a desired shape by a further molding step. The dough with low elasticity is formed into shaped articles by a common process known in the plastic processing field. For example, flat sheets can be obtained by pressing the dough into desired thickness, and other three-dimensionally shaped articles can be formed by using a die in a plastic forming processes such as extrusion, injection and compression molding. The temperature of the molding step is preferably in a range of 5° C. to 50° C., more preferably 15° C. to 40° C., furthermore preferably 20° C. to 30° C.; with respect to the low viscoelasticity of the hydrated dough.

The hydrated shaped article formed from the previous molding step must be further dried in order to achieve the desired shape to be further foam into a porous article or retain desired mechanical properties and other functions of the article. Regardless of the forming process used, once the dough is molded into a desired shape, the hydrated shaped article is placed into a drying environment to remove water and solvent residue from the shaped article, preferably at a relatively low temperature range in which the primary structure of the wheat gluten protein can be kept. The drying environment is achieved by either controlling the temperature, the humidity, or both the temperature and the humidity, which permits the escape of water molecules from the both interior and exterior of the shaped article. Preferably, the drying environment has a temperature lower than the decomposition temperature of the gluten, generally lower than 130° C., preferably in a range of 60° C. to 120° C., more preferably in a range of 70° C. to 110° C., and most preferably in a range of 80° C. to 100° C., in order to keep the primary structure of gluten protein. In some instances, the drying environment may also have a forced air that aids in the drying process. Alternatively, a very low humidity environment having a temperature less than about 60° C. is also suitable for the present invention. In another embodiment, the process may include a drying step with an elevated drying temperature range of 130° C. to 350° C., wherein thermal induced crosslinking among gluten protein molecules and active groups on the surface of the filler may occur to improve water resistance of the molded articles.

Microwave heating is applied to foam the dried product into a porous structure. The heating power and heating time can be adjusted to render the foam having desired density to fit a specific application. The density of the final product can be in a range of 1.5 to 0.005 g/cm³, preferably 1.0 to 0.01 g/cm³, more preferably 0.5 to 0.02 g/cm³, and most preferably 0.1 to 0.02 g/cm³.

### EXAMPLES

Materials: All other materials including vital wheat gluten (WG, Medley Hills Farm), Dicalcium Phosphate, Kaolin Clay powder, Gypsum powder, Distilled Water, Urea, Citric acid, Ferrous Gluconate, Graphite, expandable Graphite and Isopropyl alcohol (IPA 91% (v/v)) are commercially available without further treatment.

The flame retardation test was performed based on UL-94 HB (horizontal burning) and UV-94 V (vertical burning) test method of UL standards. A specimen having a length of about 130 mm, a width of 13 mm, and a thickness of 3 mm was used. For the UV-94 HB test, flame application time is 30 seconds for UV-94 HB test and 2×10 seconds for UV-94V test. The dried samples are further dried at 145° F. for 8 hours before the flame retardation test.

Example 1: 10 grams WG and 10 grams gypsum powder are mixed together, then 20 IPA (91%) is added, stirred to make the WG and gypsum particles evenly dispersed in the IPA. Add 30 grams of distilled water, stir the mixture around 3 to 5 minutes and then add another 90 grams of distilled water to let the WG and gypsum particles precipitate out together. A fully hydrated WG/gypsum mixture is obtained by collecting the flocculent (precipitates) and removing supernatant by filtration. Transfer the mixture into a container and dry the mixture into a plate in an oven with a pre-set drying temperature and drying time. The plate is then cut into a test sample as needed. Flame retardation test: UL-94 HB test: self-extinguished instantly. UL-94 V test satisfyies V-0.

Example 2: 10 grams WG and 10 grams Kaolin clay powder are mixed together, then 20 IPA (91%) is added, stirred to make the WG and clay particles evenly dispersed in the IPA. Add 30 grams of distilled water, stir the mixture around 3 to 5 minutes and then add another 90 grams of distilled water to let the WG and clay particles precipitate out together. A fully hydrated WG/clay mixture is obtained by collecting the flocculent and removing supernatant by filtration. Transfer the mixture into a container and dry the mixture into a plate in an oven with a pre-set drying temperature and drying time. The plate is then cut into a test sample as needed. Flame retardation test: UL-94 HB test: self-extinguished instantly. UL-94 V test satisfyies V-0.

Example 3: 10 grams WG and 10 grams dicalcium phosphate powder are mixed together, then 20 IPA (91%) is added, stirred to make the WG and dicalcium phosphate particles evenly dispersed in the IPA. Add 30 grams of distilled water, stir the mixture around 3 to 5 minutes and then add another 90 grams of distilled water to let the WG and dicalcium phosphate particles precipitate out together. A fully hydrated WG/dicalcium phosphate mixture is obtained by collecting the flocculent and removing supernatant by filtration. Transfer the mixture into a container and dry the mixture into a plate in an oven with a pre-set drying temperature and drying time. The plate is then cut into a test sample as needed. Flame retardation test: UL-94 HB test: self-extinguished instantly. UL-94 V test satisfyies V-0.

Example 4: 10 grams WG and 10 grams calcium carbonate powder are mixed together, then 20 IPA (91%) is added, stirred to make the WG and calcium carbonate particles evenly dispersed in the IPA. Add 30 grams of distilled water, stir the mixture around 3 to 5 minutes and then add another 90 grams of distilled water to let the WG and calcium carbonate particles precipitate out together. A fully hydrated WG/dicalcium phosphate mixture is obtained by collecting the flocculent and removing supernatant by filtration. Transfer the mixture into a container and dry the mixture into a plate in an oven with a pre-set drying temperature and drying time. The plate is then cut into a test sample as needed. Flame retardation test: UL-94 HB test: self-extinguished instantly. UL-94 V test satisfyies V-1.

Example 5: 10 grams WG and 10 grams graphite powder are mixed together, then 20 IPA (91%) is added, stirred to make the WG and calcium carbonate particles evenly dispersed in the IPA. Add 30 grams of distilled water, stir the mixture around 3 to 5 minutes and then add another 90 grams of distilled water to let the WG and calcium carbonate particles precipitate out together. A fully hydrated WG/dicalcium phosphate mixture is obtained by collecting the flocculent (precipitates) and removing supernatant by filtration. Transfer the mixture into a container and dry the mixture into a plate in an oven with a pre-set drying temperature and drying time. The plate is then cut into a test sample as needed. Flame retardation test: UL-94 HB test: self-extinguished in less than 30 seconds. UL-94 V test satisfyies V-1.

Example 6: 14 grams WG and 6 grams gypsum powder are mixed together, then 20 IPA (91%) is added, stirred to make the WG and gypsum particles evenly dispersed in the IPA. Add 30 grams of distilled water, stir the mixture around 3 to 5 minutes and then add another 90 grams of distilled water to let the WG and gypsum particles precipitate out together. A fully hydrated WG/gypsum mixture is obtained by collecting the flocculent and removing supernatant by filtration. Transfer the mixture into a container and dry the mixture into a plate in an oven with a pre-set drying temperature and drying time. The plate is then cut into a test sample as needed. Flame retardation test: UL-94 HB test: self-extinguished in less than 30 seconds, no flame spreaded. UL-94 V test satisfyies V-1.

Example 7: 14 grams WG, 6 grams gypsum powder and 2 grams graphite are mixed together, then 20 IPA (91%) is added, stirred to make the WG, gypsum and graphite particles evenly dispersed in the IPA. Add 30 grams of distilled water, stir the mixture around 3 to 5 minutes and then add another 90 grams of distilled water to let the WG, gypsum particles and graphite particles precipitate out together. A fully hydrated WG/gypsum/graphite mixture is obtained by collecting the flocculent and removing supernatant by filtration. Transfer the mixture into a container and dry the mixture into a plate in an oven with a pre-set drying temperature and drying time. The plate is then cut into a test sample as needed. Flame retardation test: UL-94 HB test: self-extinguished in less than 20 seconds, no flame spreaded. UL-94 V test satisfyies V-1.

Example 8: 14 grams WG and 6 grams gypsum powder are mixed together, then 20 IPA (91%) is added, stirred to make the WG and gypsum particles evenly dispersed in the IPA. Add 30 grams of distilled water, stir the mixture around 3 to 5 minutes and then add another 90 grams of distilled water to let the WG and gypsum particles precipitate out together. A fully hydrated WG/gypsum mixture is obtained by collecting the flocculent, removing supernatant by filtration, and further mixing 2 grams urea into the mixture. Transfer the urea loaded mixture into a container and dry the mixture into a plate in an oven with a pre-set drying temperature and drying time. The plate is then cut into a test sample as needed. Flame retardation test: UL-94 HB test: self-extinguished instantly, no flame spreaded. UL-94 V test satisfyies V-0.

Example 9: 14 grams WG and 6 grams gypsum powder are mixed together, then 20 IPA (91%) is added, stirred to make the WG and gypsum particles evenly dispersed in the IPA. Add 30 grams of distilled water, stir the mixture around 3 to 5 minutes and then add another 90 grams of distilled water to let the WG and gypsum particles precipitate out together. A fully hydrated WG/gypsum mixture is obtained by collecting the flocculent, removing supernatant by filtration, and further mixing 2 grams citric acid into the mixture. Transfer the Ascorbic acid loaded mixture into a container and dry the mixture into a plate in an oven with a pre-set drying temperature and drying time. The plate is then cut into a test sample as needed. The test sample instantly expands into a foamed structure when a test flame is applied. Flame retardation test: UL-94 HB test: self-extinguished in less than 30 seconds, no flame spreaded. UL-94 V test satisfyies V-1.

Example 10: 14 grams WG, 6 grams gypsum powder and 2 grams graphite are mixed together, then 20 IPA (91%) is added, stirred to make the WG, gypsum and graphite particles evenly dispersed in the IPA. Add 30 grams of distilled water, stir the mixture around 3 to 5 minutes and then add another 90 grams of distilled water to let the WG, gypsum particles and graphite particles precipitate out together. A fully hydrated WG/gypsum/graphite mixture is obtained by collecting the flocculent (precipitates) and removing supernatant by filtration, and further mixing 2 grams urea into the mixture. Transfer the urea loaded mixture into a container and dry the mixture into a plate in an oven with a pre-set drying temperature and drying time. The plate is then cut into a test sample as needed. Flame retardation test: UL-94 HB test: self-extinguished instantly, no flame spreaded. UL-94 V test satisfyies V-0.

Example 11: 14 grams WG, 6 grams gypsum powder and 2 grams graphite are mixed together, then 20 IPA (91%) is added, stirred to make the WG, gypsum and graphite particles evenly dispersed in the IPA. Add 30 grams of distilled water, stir the mixture around 3 to 5 minutes and then add another 90 grams of distilled water to let the WG, gypsum particles and graphite particles precipitate out together. A fully hydrated WG/gypsum/graphite mixture is obtained by collecting the flocculent and removing supernatant by filtration, and further mixing 2 grams urea and 2 grams citric acid into the mixture. Transfer the urea and Ascorbic acid loaded mixture into a container and dry the mixture into a plate in an oven with a pre-set drying temperature and drying time. The plate is then cut into a test sample as needed. The test sample instantly expands into a foamed structure when a test flame is applied. Flame retardation test: UL-94 HB test: self-extinguished in 10 seconds, no flame spreaded. UL-94 V test satisfyies V-1.

Example 12: 10 grams casein, 10 grams gypsum powder are mixed together, then 20 IPA (91%) is added, stirred to make the casein and gypsum evenly dispersed in the IPA. Add 40 grams NaOH 5% by weight water solution and then 2 grams urea. Stir the mixture around 5 to 10 minutes to let the casein and gypsum particles form a slurry. Transfer the slurry into a container and dry the mixture into a plate in an oven with a pre-set drying temperature and drying time. The plate is then cut into a test sample as needed. Flame retardation test: UL-94 HB test: self-extinguished instantly, no flame spreaded. UL-94 V test satisfyies V-0.

Example 13: 18 grams WG and 2 grams graphite are mixed together, then 20 IPA (91%) is added, stirred to make the WG and graphite particles evenly dispersed in the IPA. Add 30 grams of distilled water, stir the mixture around 3 to 5 minutes and then add another 90 grams of distilled water to let the WG and graphite particles precipitate out together. A fully hydrated WG/graphite mixture is obtained by collecting the flocculent (precipitates) and removing supernatant by filtration. Transfer the mixture into a container and dry the mixture into a plate in an oven with a pre-set drying temperature and drying time. The plate is then cut into a test sample as needed. Microwave heating at 100% power level for 30 seconds to form a foamed product with density about 0.025 g/cm³.

Example 14: 18 grams WG and 2 grams expandable graphite are mixed together, then 20 IPA (91%) is added, stirred to make the WG, expandable graphite particles evenly dispersed in the IPA. Add 30 grams of distilled water, stir the mixture around 3 to 5 minutes and then add another 90 grams of distilled water to let the WG and expandable graphite particles precipitate out together. A fully hydrated WG/expandable graphite mixture is obtained by collecting the flocculent (precipitates) and removing supernatant by filtration. Transfer the mixture into a container and dry the mixture into a plate in an oven with a pre-set drying temperature and drying time. The plate is then cut into a test sample as needed. Microwave heating at 100% power level for 60 seconds to form a foamed product with density about 0.025 g/cm³.

1. A flame retardation thermal interface material composition comprising a protein, a char forming promotor, and a char reinforce agent.

2. The flame retardation thermal interface material composition according to claim 1, wherein the protein includes at least one of wheat gluten, casein, collagen, gelatin or soy-protein.

3. The flame retardation thermal interface material composition according to claim 2, wherein the protein includes a wheat gluten.

4. The flame retardation thermal interface material composition according to claim 1, wherein the char forming promoter is an inorganic particle.

5. The flame retardation thermal interface material composition according to claim 4, wherein the inorganic particles include at least one of silicon oxide, titanium oxide, calcium phosphate, dicalcium phosphate, gypsum or clay.

6. The flame retardation thermal interface material composition according to claim 4, wherein the inorganic particle has a particle size of 0.1 to 500 microns.

7. The flame retardation thermal interface material composition according to claim 4, wherein the inorganic particle has a content of 5 to 80% by weight with respect to the total composition.

8. The flame retardation thermal interface material composition according to claim 1, wherein the char reinforce agent includes at least one of fibrous mineral particle, plate-like particle or carbon-based particle.

9. The flame retardation thermal interface material composition according to claim 8, wherein the fibrous mineral particle includes at least one of tremolite, chrysotile or riebeckite.

10. The flame retardation thermal interface material composition according to claim 8, wherein the plate-like particle includes at least one of talc, mica, expandable kaolin clay, expendable vermiculite or expandable perlite.

11. The flame retardation thermal interface material composition according to claim 8, wherein the carbon-based particle includes at least one of graphite, expandable graphite, carbon nanotube, carbon nanofiber, graphene, or graphene oxide.

12. The flame retardation thermal interface material composition according to claim 8, wherein the char reinforce agent has a content of 1 to 30% by weight with respect to total composition.

13. The flame retardation thermal interface material composition according to claim 1, further comprising a foaming agent, wherein the foaming agent includes one of a low temperature foaming agent, a high temperature foaming agent or a combination thereof.

14. The flame retardation thermal interface material composition according to claim 13, wherein the low temperature foaming agent has a decomposition temperature in a range of 150° C. to 350° C.

15. The flame retardation thermal interface material composition according to claim 13, wherein the low temperature foaming agent has a content of 1 to 20% by weight with respect to total composition.

16. The flame retardation thermal interface material composition according to claim 13, wherein the high temperature foaming agent has a decomposition temperature in a range of 400° C. to 600° C.

17. The flame retardation thermal interface material composition according to claim 13, wherein the high temperature foaming agent has a content of 1 to 20% by weight with respect to total composition.

18. The flame retardation thermal interface material composition according to claim 1, comprising a porous structure having a density in a range of 1.5 to 0.01 g/cm³.

19. The flame retardation thermal interface material composition according to claim 1, further comprising a flame suppression agent.

20. The flame retardation thermal interface material composition according to claim 1, further comprising a thermal conductive agent.
